(19) United States
(12) Patent Application Publication
(10) Pub. No.: US 2025/0019468 A1
(43) Pub. Date: Jan. 16, 2025

(54) UPGRADED DRAFT TUBE FOR OLEFIN FLUIDIZED BED POLYMERIZATION

(71) Applicant: SABIC GLOBAL TECHNOLOGIES B.V., Bergen op Zoom (NL)

(72) Inventors: Byron Smith John Rajarethnam, Bangalore (IN); Musaad Al-Sadhan, Riyadh (SA); Ravi Ranjan Kumar, Jubail (SA); Retheesh Madhusudanan Vanchiyil, Bangalore (IN); Hesham Al-Shobilly, Riyadh (SA); Erik René Delsman, Eindhoven (NL)

(21) Appl. No.: 18/712,084

(22) PCT Filed: Nov. 14, 2022
(86) PCT No.: PCT/EP2022/081859

§ 371 Date: May 21, 2024

(30) Foreign Application Priority Data
Nov. 22, 2021 (EP) 21209616.8

(51) Int. Cl. C08F 2/01; B01J 8/18; B01J 8/26; C08F 2/34; C08F 10/06

(52) U.S. Cl. CPC C08F 2/01; B01J 8/1872; B01J 8/26; C08F 2/34; C08F 10/06; B01J 2208/00938; B01J 2208/00991

(57) ABSTRACT

Process for the polymerization of one or more monomers in a fluidized bed reactor, which reactor comprises a reaction zone which is confined at the underside by a gas distribution plate and at the top side by a virtual end surface, in which a fluidized bed is maintained between the underside and the top side, and in which at least part of the gaseous stream withdrawn from the top of the reactor is cooled to a point where the stream partially condenses into a liquid and in which at least part of the resulting two-phase stream is recycled to the reactor via an inlet which terminates in the reactor below the gas distribution plate, wherein, the reaction zone of the reactor is divided into two compartments by a draft tube extending from a point located above the gas distribution plate such that the area ratio of the circumferential draft tube inlet area (Ahb) to annular area (Aa) is between 0.5 to 3, preferably 2, to a point located below the end surface.

### CROSS REFERENCE TO RELATED APPLICATIONS

This application is a National Stage application of PCT/EP2022/081859, filed Nov. 14, 2022, which claims the benefit of European Application No. 21209616.8 filed Nov. 22, 2021, both of which are incorporated by reference in their entirety herein.

### TECHNICAL FIELD OF THE INVENTION

The present invention relates to a draft tube and its use for the polymerization of olefin within a vertical reactor having a fluidized bed.

### TECHNOLOGICAL BACKGROUND OF THE INVENTION

The use of a draft tube for the polymerization of olefin within a vertical reactor having a fluidized bed is well known.

EP1196238 describes a Process for the polymerization of one or more monomers in a fluidized bed reactor, which reactor comprises a reaction zone which is confined at the underside by a gas distribution plate and at the top side by a virtual end surface, in which a fluidized bed is maintained between the underside and the top side, and in which at least part of the gaseous stream withdrawn from the top of the reactor is cooled to a point where the stream partially condenses into a liquid and in which at least part of the resulting two-phase stream is recycled to the reactor via an inlet which terminates in the reactor below the gas distribution plate, wherein, the reaction zone of the reactor is divided into two compartments by a draft tube extending from a point located above the gas distribution plate to a point located below the end surface.

However, in the operation of the gas phase poly-olefin reactor, with a draft tube inserted in the reactor, a single circulation loop for poly olefin resin is needed for the successful operation of the reactor. The length of the draft tube plays an important role in the particle circulation velocity, which is an outcome of the pressure difference between the draft tube ends.

Nevertheless, the length of the draft tube will be restrained by the height of fluidized bed level above the draft tube top. Moreover, if the draft tube is not sufficiently submerged below the bed level, the formation of the resin circulation loop is affected and the bed will behave similar to a normal fluidized bed reactor and the benefits of draft tube reactor cannot be achieved.

Therefore, there is a need for a process to determine the perfect length of the draft tube, in order to optimize the reactor setup and obtain the best polymerization rate minimizing loss of production and instability in the operation of the reactor.

### SUMMARY

This object is achieved by the present invention. Accordingly, the present invention relates to a process for the polymerization of one or more monomers in a fluidized bed reactor, which reactor comprises a reaction zone which is confined at the underside by a gas distribution plate (3) and at the top side by a virtual end surface, in which a fluidized bed is maintained between the underside and the top side, and in which at least part of the gaseous stream withdrawn from the top of the reactor is cooled to a point where the stream partially condenses into a liquid and in which at least part of the resulting two-phase stream is recycled to the reactor via an inlet which terminates in the reactor below the gas distribution plate,
wherein, the reaction zone of the reactor is divided by a draft tube, preferably a hallow cylindrical tube positioned inside the cylindrical section (6) of the reactor, into two zones, a draft tube zone (4) and an annular zone (5) extending from a point located above the gas distribution plate such that the area ratio of the circumferential draft tube zone (Ahb) to annular zone (Aa) is between 0.5 to 3, preferably 2, to a point located below the end surface
characterized in that the distance Lj (in meter) between the end of the draft tube and the virtual end surface fulfilling one of the following equations:
   when the flow in the annulus u_{c} is >2.5 times the minimum fluidization velocity u_{mf}

$$0.3 + d \times 11.5 \times F {r}^{* 0.1966} \leq L j \leq 0.5 + d \times 11.5 \times F {r}^{* 0.1966}$$

when the flow in the annulus u_{c} is ≤2.5 times the minimum fluidization velocity u_{mf}

$$0.3 + d \times 19.18 \times {( \frac{u}{{u}_{m f}} )}^{- 0.3616} \times F {r}^{* 0.2383} \leq Lj \leq 0. 5 + d \times 19.18 \times {( \frac{u}{{u}_{m f}} )}^{- 0.3616} \times F {r}^{* 0.2383}$$

wherein
Fr* is two phase Froude Number, calculated by the following equation:

$$F {r}^{*} = \frac{{ρ}_{f}}{{ρ}_{p} - {ρ}_{f}} \times \frac{{u}^{2}}{g d} ;$$

ρᵣ is the fluid density (kg/m³);
ρₚ is the solid density (kg/m³);
u is the superficial gas velocity (m/s);
d is diameter of the draft tube (m);
g is the gravitational constant (9.81 m/s)
u is the superficial gas velocity (m/s);
u_{c} is the annular gas velocity (m/s);
u_{mf} is the minimum fluidization velocity (m/s).

In another embodiment, the draft tube is concentric to the reaction zone.

In another embodiment, the resulting two-phase stream is recycled to the reactor as a gas-liquid mixture.

In another embodiment, at least part of the condensed liquid is separated from the two-phase stream and directly introduced into the fluid bed.

In another embodiment, the height/diameter ratio of the fluid bed is greater than 5.0.

In another embodiment, the mass ratio of (liquid supplied to the reactor):(the amount of gas supplied to the reactor) is higher than 2:1.

In another embodiment, at least one of the monomers is ethylene or propylene.

In another embodiment, the polymerization is performed at a pressure of between 0.5 and 10 MPa.

In another embodiment, the polymerization is performed at a temperature of between 3° and 130° C.

Another aspect of the invention is a reactor system, suitable for polymerizing one or more monomers, comprising a fluid bed reactor, having at the underside a gas distribution plate, having means for the supply of reaction ingredients, having means for the withdrawal of a gaseous stream from the top of the reactor, having a cooler/condensor for cooling said gaseous stream to a point where said stream partially condenses into a liquid, and having means for recirculating the stream out of the cooler/condensor to the reactor, in the reactor, the reaction zone is divided into two compartments by a draft tube extending from a point above the gas distribution plate such that the area ratio of the circumferential draft tube inlet area (Ahb) to annular area (Aa) is between 0.5 to 3, preferably 2 and characterized in that the draft tube end to a distance Lj (in meter) from the top end of the reaction zone wherein 0.3+d×11.5×Fr^{*0.1966}<Lj<0.5+d×11.5×Fr^{*0.1966}
wherein
Fr* is two phase Froude Number, calculated by the following equation:

$${Fr}^{*} = \frac{{ρ}_{f}}{{ρ}_{p} - {ρ}_{f}} \times \frac{{u}^{2}}{g d} ;$$

ρ_{f} is the fluid density (kg/m³);
ρₚ is the solid density (kg/m³);
u is the superficial gas velocity (m/s);
d is diameter of the draft tube (m);
g is the gravitational constant (9.81 m/s).

In another embodiment, the draft tube is concentric with the reactor.

In another embodiment, the high/diameter ratio of the reactor is greater than 5.

In another embodiment, the ratio of the area of the radial cross section of the pipe or hollow section to that of the reactor is between 1:5 and 3:4.

In another embodiment, the reactor system comprises means for recirculating the stream out of the cooler/condensor to the reactor as a gas-liquid mixture.

In another embodiment, the reactor system comprises a gas liquid separator to separate at least part of the condensed liquid out of the resulting two-phase stream from the cooler/condensor and means for introducing at least part of the separated liquid into the fluidized bed reactor.

### BRIEF DESCRIPTION OF THE DRAWINGS

FIG. 1 shows a draft tube according to an embodiment.

### DETAILED DESCRIPTION

The conventional gas phase polyolefin reactor consists of a gas inlet (1), annular disk (2) inside the plenum chamber, a distributor plate (3), a cylindrical body (6), an expanded dome (7) and the gas outlet (8).

The polyolefin gas phase reactor temperature is controlled by the cycle gas properties, its flow and the fraction of condensate added to it. This condensate has a major role in heat removal as it evaporates inside the reactor and this heat of evaporation is used to cool the reactor.

The ability to introduce more condensate (higher condensation fraction called condensed mode operation) will help improve the production rate in the reactor.

The use of a draft tube inside the reactor will help in diverting more cycle gas and condensate in to the draft tube, thus allowing increase in production.

The draft tube is preferably a hallow cylindrical tube positioned inside the cylindrical section of the reactor in such a way that it creates a draft tube zone (4) and an annular zone (5).

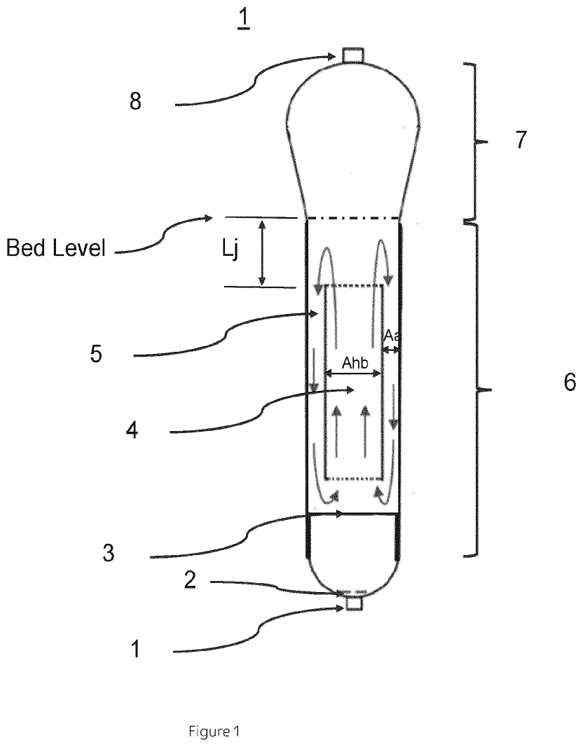

This draft tube is submerged in the fluidized bed to create a circulation pattern as seen in FIG. 1.

A detailed literature survey also did not yield any guidelines for the submergence. From practical operation of the draft tube reactor it was found that:
If the draft tube is not sufficiently submerged below the bed level, the reactor could not be stably operated and the single circulation loop which provides the benefit of the draft tube could not be achieved and the draft tube reactor operates like a conventional reactor.
If the draft tube is too much submerged from the bed level, the single circulation loop which provides the benefit of the draft tube is dissipated and the draft tube reactor operates like a conventional reactor

Even though the patent EP1196238 describes that it is far less critical for the bed to extend further beyond the draft tube at the upper end than at the lower end, and stated that the upper end of the draft tube can be submerged at least 0.1× the diameter of the reaction zone below the end of that reaction zone and preferably not more than 3× that diameter.

Applicant realized that following the above recommendation does not provide the best environment and some turbulence at the upper end of the fluidized bed (or reaction zone) can be present disturbing the circulation loop as if the draft tube is not sufficiently submerged the flow passing through is projected beyond the fluidized bed and no benefit of draft tube can be obtained from the reactor.

Efforts were made to identify the reason for keeping the draft tube submerged and how much of submergence was required for the operation to be stable.

The draft tube operates on the basis of the pressure difference created between the two ends of the draft tube and this induces a solid circulation velocity. It has been identified based on the experiments carried out in a commercial scale reactor that the solid circulation velocity in the reactor should exceed at least 1.6-2.0 m/s for the smooth operation of the reactor.

During this investigation, applicant surprisingly realized that the draft tube is having a similar behavior as a nozzle, and therefore having a Jet Penetration Length (JPL), which will impact the reactor behavior.

In addition, it has been found that the solid circulation velocity is directly related to the height of the draft tube. The restriction on this height will be enforced by the minimum submergence required for the top end of the draft tube below the fluidized bed level.

In the draft tube, the superficial velocity is higher than the annulus section and it carries along with it the polyolefin resins. The carrying of resin and the upward movement of gases from the annulus section will have an impact on the JPL of gases from the draft tube.

Surprisingly, applicant found that using an adaptation of the correlation (I) found by Q. Guo et al. (Chemical Engineering Science 56 (2001) 4685-4694),

$$0 < {u}_{c} \leq 2.5 {u}_{mf} \frac{h}{d} = 19.18 {( \frac{u}{{u}_{mf}} )}^{- 0.3616} {F}_{r}^{* 0.2383} \qquad ( I )$$

$${u}_{c} > 2.5 {u}_{mf} \frac{h}{d} = 11.52 {F}_{r}^{* 0.1966}$$

$${F}_{r}^{*} = \frac{{ρ}_{f}}{{ρ}_{p - {ρ}_{f}}} \frac{{u}^{2}}{gd}$$

Fr* is two phase Froude Number,
ρ_{f} is the fluid density (kg/m³);
ρₚ is the solid density (kg/m³);
u is the superficial gas velocity (m/s);
u_{c} is the annular gas velocity (m/s);
u_{mf} is the minimum fluidization velocity (m/s);
d is diameter of the draft tube (m);
g is the gravitational constant (9.81 m/s);
h is the Jet Penetration Length (m).

it has been possible to predict the jet penetration length of the draft tube and match with a bed level to obtain the reactor to operate in a stable and optimal manner.

In Particular, it has be found that a good operation is achieved when the bed level is at least 0.2 above the jet penetration length calculated for the reactor, preferably approximately 0.3-0.5 m, advantageously about 0.4 m.

By determining the right height of the draft tube, the vertical mixing is enhanced as well as the higher liquid loading handled by the draft tube, therefore the temperature gradient across reactor fluidized bed is less than the conventional gas phase reactors leading to, enhanced product quality, uniform Mw distribution and uniform particle size distribution (PSD), reactor continuity and stability.

In addition, the improve single circulation loop for resin movement, created by the draft tube according to the invention, helps in preventing liquid monomer loss to the product discharge system, thereby reducing purging requirements and reducing the dissolved monomer losses about 0.5 to 1%.

In some embodiment, the catalyst is injected at the bottom of the draft tube and entrained upwards, the slippage of unreacted catalyst to the downstream operations is prevented and this provides higher catalyst yield. This also increases the residence time of the catalyst.

In addition, the reduction in hydrocarbon slippage downstream results in reduced hydrocarbon in resin provides better process safety of equipment downstream of reactor.

In some embodiment, the draft tube is supported by the distribution plate by the means of legs extending from the draft tube to the distribution plate.

In some embodiment, the draft tube comprises spacers extending from the wall of the draft tube to the wall of the reactor. Such spacers may be present at different heights of the draft tube to prevent vibration of the draft tube within the reactor, preferentially such spacer could be place between 30 and 60% of the height of the draft tube and additional space could be place at the upper end.

Such embodiment prevents to fix the draft tube to the wall of the reactor risking jeopardizing the integrity of the reactor, and allowing retrofit of existing reactors without modifying the exterior shell of the reactor.

In some embodiment, a conical convergent skirt attached to the draft tube at the bottom and the catalyst injection protruding in this skirt. The skirt can also be wrapped around the leg support for the draft tube. Such skirt at the bottom of the draft tube can increase the gas flow to the draft tube and can reduce the bubble raising in the annular section allowing the single powder circulation loop.

In some embodiment, a conical divergent skirt attached to the draft tube at the top can help smooth transition of growing resin particles above the draft tube.

In some embodiment, the draft tube may comprise the conical convergent skirt and the conical divergent skirt.

In some embodiment, the distributor plate has three distinct areas on it, core, annular and peripheral, which occupy respectfully 30%, 30% and 40% of the distributor plate surface. Each distinct areas have a multitude of opening on it and their respective open area ratio are 45% (core), 35% (annular) and 20% (peripheral). This leads to 65% of the flow directed in to the draft tube.

In some embodiment, the distributor plate is supported by a honeycomb grid protruding below the plate

### EXAMPLE

In a draft tube reactor where the draft tube diameter is 50% of the reactor diameter, the superficial gas velocity of the reactor is 0.3 m/s and the superficial gas velocity inside the draft tube is 0.417 m/s. The draft tube fluidized bed is operated with a cycle gas density of 76 kg/m3 and resin density of 820 kg/m3. The diameter of the draft tube is 2.31 m.

Since the flow in the annulus is >2.5 times the minimum fluidization velocity, the second correlation is used

$${u}_{c} > 2.5 {u}_{mf} \frac{h}{d} = 11.52 {F}_{r}^{* 0.1966}$$

Two Phase Froude number:

$${F}_{r}^{*} = \frac{{ρ}_{f}}{{ρ}_{p} - {ρ}_{f}} \frac{{u}^{2}}{gd} = \frac{76}{820 - 76} \frac{{0.417}^{2}}{9.81 * 2.31} = 7.838 \times {10}^{- 4}$$

### Jet Penetration Length:

$$h = d * 11.5 * {{F}_{r}}^{* 0.1966} = 2.31 * 11.5 * {( 7.838 \times {10}^{- 4} )}^{0.1966} = 6.525 m$$

The commercial reactor operates in a stable manner without disturbances for a bed level of 6.88 m above the draft tube top. This is 0.355 m above the calculated Jet Penetration Length by the Guo correlation.

1. Process for the polymerization of one or more monomers in a fluidized bed reactor, which reactor comprises a reaction zone which is confined at the underside by a gas distribution plate (3) and at the top side by a virtual end surface, in which a fluidized bed is maintained between the underside and the top side, and in which at least part of the gaseous stream withdrawn from the top of the reactor is cooled to a point where the stream partially condenses into a liquid and in which at least part of the resulting two-phase stream is recycled to the reactor via an inlet which terminates in the reactor below the gas distribution plate, wherein, the reaction zone of the reactor is divided by a draft tube into two zones, a draft tube zone (4) and an annular zone (5) extending from a point located above the gas distribution plate such that the area ratio of the circumferential draft tube zone (Ahb) to annular zone (Aa) is between 0.5 to 3 to a point located below the end surface,
characterized in that the distance Lj (in meter) between the end of the draft tube and the virtual end surface is fulfilling the one of the following equations:
when the flow in the annulus uₑ is >2.5 times the minimum fluidization velocity u_{mf}
$$0.3 + d \times 11.5 \times F {r}^{* 0.1966} \leq L j \leq 0.5 + d \times 11.5 \times F {r}^{* 0.1966}$$
when the flow in the annulus uₑ is ≤2.5 times the minimum fluidization velocity u_{mf}
$$0.3 + d \times 19.18 \times {( \frac{u}{{u}_{m f}} )}^{- 0.3616} \times F {r}^{* 0.2383} \leq Lj \leq 0. 5 + d \times 19.18 \times {( \frac{u}{{u}_{m f}} )}^{- 0.3616} \times F {r}^{* 0.2383}$$
wherein
Fᵣ* is two phase Froude Number, calculated by the following equation
$${Fr}^{*} = \frac{{ρ}_{f}}{{ρ}_{p} - {ρ}_{f}} \times \frac{{u}^{2}}{g d} ;$$
ρ_{f} is the fluid density (kg/m³);
ρₚ is the solid density (kg/m³);
u is the superficial gas velocity (m/s);
d is diameter of the draft tube (m);
g is the gravitational constant (9.81 m/s)
u is the superficial gas velocity (m/s);
u_{c} is the annular gas velocity (m/s);
u_{mf} is the minimum fluidization velocity (m/s).

2. Process according to claim 1 characterized in that the draft tube is concentric to the reaction zone.

3. Process according to claim 1, characterized in that the resulting two-phase stream is recycled to the reactor as a gas-liquid mixture.

4. Process according to claim 1, characterized in that at least part of the condensed liquid is separated from the two-phase stream and directly introduced into the fluid bed.

5. Process according to claim 1, characterized in that the height/diameter ratio of the fluid bed is greater than 5.0.

6. Process according to claim 1, characterized in that the mass ratio of (liquid supplied to the reactor):(the amount of gas supplied to the reactor) is higher than 2:1.

7. Process according to claim 1, characterized in that at least one of the monomers is ethylene or propylene.

8. Process according to claim 1, characterized in that the polymerization is performed at a pressure of between 0.5 and 10 MPa.

9. Process according to claim 1, characterized in that the polymerization is performed at a temperature of between 3° and 130° C.

10. Reactor system, suitable for polymerizing one or more monomers, comprising a fluid bed reactor, having at the underside a gas distribution plate, having means for the supply of reaction ingredients, having means for the withdrawal of a gaseous stream from the top of the reactor, having a cooler/condensor for cooling said gaseous stream to a point where said stream partially condenses into a liquid, and having means for recirculating the stream out of the cooler/condensor to the reactor, in the reactor, the reaction zone is divided into two compartments by a draft tube such that the area ratio of the circumferential draft tube inlet area (Ahb) to annular area (Aa) is between 0.5 to 3, and
characterized in that the draft tube end to a distance Lj (in meter) from the top end of the reaction zone and wherein Lj (in meter) is determined by one of the following equations
when the flow in the annulus u_{c} is >2.5 times the minimum fluidization velocity u_{mf}
$$0.3 + d \times 11.5 \times F {r}^{* 0.1966} \leq L j \leq 0.5 + d \times 11.5 \times F {r}^{* 0.1966}$$
when the flow in the annulus u_{c} is ≤2.5 times the minimum fluidization velocity u_{mf}
$$0.3 + d \times 19.18 \times {( \frac{u}{{u}_{m f}} )}^{- 0.3616} \times F {r}^{* 0.2383} \leq Lj \leq 0. 5 + d \times 19.18 \times {( \frac{u}{{u}_{m f}} )}^{- 0.3616} \times F {r}^{* 0.2383}$$
wherein
Fᵣ* is two phase Froude Number, calculated by the following equation:
$${Fr}^{*} = \frac{{ρ}_{f}}{{ρ}_{p} - {ρ}_{f}} \times \frac{{u}^{2}}{g d} ;$$
p_{f} is the fluid density (kg/m³);
pₚ is the solid density (kg/m³);
u is the superficial gas velocity (m/s);
d is diameter of the draft tube (m);
g is the gravitational constant (9.81 m/s).

11. Reactor system according to claim 10, characterized in that the draft tube is concentric with the reactor.

12. Reactor system according to claim 10, characterized in that the high/diameter ratio of the reactor is greater than 5.

13. Reactor system according claim 10, characterized in that the ratio of the area of the radial cross section of draft tube to that of the reactor is between 1:5 and 3:4.

14. Reactor system according claim 10, characterized in that the reactor system comprises means for recirculating the stream out of the cooler/condensor to the reactor as a gas-liquid mixture.

15. Reactor system according claim 10, characterized in that the reactor system comprises a gas liquid separator to separate at least part of the condensed liquid out of the resulting two-phase stream from the cooler/condensor and means for introducing at least part of the separated liquid into the fluidized bed reactor.
